(19) United States
(12) Patent Application Publication
(10) Pub. No.: US 2025/0063478 A1
(43) Pub. Date: Feb. 20, 2025

(54) Handling Attribute Updates and Commands Between a Digital Twin and Wi-Fi IoT Power Constrained Device with an Extended Sleep Duration

(71) Applicant: Silicon Laboratories Inc., Austin, TX (US)

(72) Inventors: Manav Kumar Mehta, Hyderabad (IN); Hasan Ali Stationwala, Hyderabad (IN); Atul Suresh Joshi, Pune (IN); Mathieu Kardous, Montréal (CA); Ashish Bajaj, Hyderabad (IN)

(21) Appl. No.: 18/529,282

(22) Filed: Dec. 5, 2023

Related U.S. Application Data
(60) Provisional application No. 63/532,552, filed on Aug. 14, 2023.

(51) Int. Cl. H04W 48/16; H04W 48/20; H04W 60/04; H04W 60/06

(52) U.S. Cl. CPC H04W 48/16; H04W 48/20; H04W 60/04; H04W 60/06

(57) ABSTRACT

A system and various methods to implement a Digital Twin with a low power Wi-Fi device is disclosed. The low power Wi-Fi device seeks a Digital Twin at the time of commissioning to serve as its proxy node while it is in sleep mode. Additionally, techniques to address the situation where the Digital Twin becomes unavailable are also disclosed. Finally, techniques to create and update a chain of Digital Twins are also disclosed.

This application claims priority from U.S. Provisional Patent Application Ser. No. 63/532,552, filed Aug. 14, 2023, the disclosure of which is incorporated herein by reference in its entirety.

### FIELD

This disclosure describes a system and various methods to implement a Digital Twin with a low power Wi-Fi device.

### BACKGROUND

The Wi-Fi protocol was originally designed to include devices which have access to unlimited power. Thus, early revisions of the specification did not include any provisions to support low power devices, which need to enter low power modes in order to conserve battery life. For example, some devices, such as sensor devices, should ideally have a battery life that is more than one year.

The Wi-Fi protocol was updated to include some power saving modes of operation. For example, one of the power saving mechanisms available is PS-Poll. In this mode, the low power Wi-Fi device notifies the access point that it is entering a sleep mode. The access point will then buffer all outbound messages for this low power Wi-Fi node. If it has any outbound packets for this device, it indicates this in its beacon message. After waking, the low power Wi-Fi device checks the beacon message and if there are stored messages, it transmits a packet to the access point requesting the stored packets.

Another update is the inclusion of target wake times (TWT). This feature allows the low power Wi-Fi device to specify when it will be awake and for how long. In this embodiment, all data for the low power Wi-Fi device are transmitted during a predetermined interval referred to as the TWT service period. This is intended to allow longer periods of sleep mode and also reduce contention by allotting specific intervals for transmissions to each device.

A third update is referred to as Basic Service Set Max Idle (BSS Max Idle). This allows the access point to maintain its association with a low power Wi-Fi device even if it has not received any keep-alive communications from that device for an extended period of time.

However, these techniques all have drawbacks. The PS Poll feature has shown interoperability issues when the listen interval exceeds several seconds. The TWT and BSS Max idle features are ineffective when the wake frequency is too high, which may be required to increase battery life in devices like sensors. On the other hand, if the wake frequency is too low, it results in interoperability issues, such as disconnections.

BSS Max Idle also suffers from increased power consumption due to channel contention back off's, which is not addressed in this feature.

Therefore, it would be beneficial if there was a system and method that allows low power Wi-Fi devices to remain in low power mode for extended periods of time without requiring communication with the access point.

### SUMMARY

A system and various methods to implement a Digital Twin with a low power Wi-Fi device is disclosed. The low power Wi-Fi device seeks a Digital Twin at the time of commissioning to serve as its proxy node while it is in sleep mode. Additionally, techniques to address the situation where the Digital Twin becomes unavailable are also disclosed. Finally, techniques to create and update a chain of Digital Twins are also disclosed.

According to one embodiment, a method for creating a Digital Twin node for a low power Wi-Fi device in a Wi-Fi network is disclosed. The method comprises issuing from the low power Wi-Fi device, a groupcast “discovery message” to identify proxy nodes that are able to serve as the Digital Twin node; receiving, at the low power Wi-Fi device, responses from proxy nodes that are able to serve as the Digital Twin node; selecting a first proxy node of the proxy nodes as the Digital Twin node and forming an association with the first proxy node; and assigning a recency score to the Digital Twin node, which is indicative of how recently the association was formed, wherein the recency score is used by a controller to identify a most recent Digital Twin node associated with the low power Wi-Fi device. In some embodiments, each time the low power Wi-Fi device forms an association with one of the proxy nodes, it assigns a different recency score. In some embodiments, each time the low power Wi-Fi device forms an association with one of the proxy nodes, it increases the recency score. In some embodiments, after the association is formed, the Digital Twin node becomes unavailable, and, in response, the low power Wi-Fi device disassociates from the Digital Twin node; issues a groupcast “discovery message” to identify proxy nodes that are able to serve as a new Digital Twin node; receives responses from proxy nodes that are able to serve as the new Digital Twin node; selects a second proxy node of the proxy nodes as the new Digital Twin node and forms a new association with the second proxy node; and assigns a second recency score to the new Digital Twin node, different from the recency score assigned to the Digital Twin node. In certain embodiments, after the new association is formed, the Digital Twin node becomes available, and the Digital Twin node transmits a groupcast “discover query” with a unique node identifier associated with the low power Wi-Fi device to discover if there are other Digital Twin nodes in the Wi-Fi network; receives a response from the new Digital Twin node, wherein the response includes the second recency score; compares the second recency score to its recency score and determines that it is no longer associated with the low power Wi-Fi device; and disassociates itself from the low power Wi-Fi device. In certain embodiments, after the low power Wi-Fi device forms the new association, the controller issues a query to discover proxy nodes associated with the low power Wi-Fi device; receives a response from the Digital Twin node and the new Digital Twin node; compares the second recency score to the recency score assigned to the Digital Twin node; and selects the new Digital Twin node to communicate with regarding the low power Wi-Fi device, based on the recency score and the second recency score. In some embodiments, after the association is formed, the low power Wi-Fi device also assigns a link code to the Digital Twin node.

According to another embodiment, a method of configuring and maintaining a chain of Digital Twin nodes is disclosed. The method comprises forming a chain using a plurality of Digital Twin nodes between a controller and a low power Wi-Fi device, wherein a first Digital Twin node is closest to the low power Wi-Fi device and a second Digital Twin node is closest to the controller; and assigning each Digital Twin node in the chain a unique link code, wherein the link code is indicative of a position of a respective Digital Twin node in the chain. In some embodiments, the method comprises creating an association between pairs of adjacent Digital Twin nodes in the chain; and assigning a recency score to each association, which is indicative of when the association was formed. In some embodiments, after a third Digital Twin node in the chain, disposed between the first Digital Twin node and the second Digital Twin node, becomes unavailable, Digital Twin nodes on either side of the third Digital Twin node, referred to as a near-side neighbor and a far-side neighbor, associate with each other. In some embodiments, all Digital Twin nodes disposed between the third Digital Twin node and the controller are assigned new link codes. In certain embodiments, link codes of all Digital Twin nodes disposed between the third Digital Twin node and the controller are decremented. In some embodiments, the far-side neighbor receives a new recency score. In some embodiments, the near-side neighbor and the far-side neighbor are assigned new recency scores. In another embodiment, after a third Digital Twin node in the chain, disposed between the first Digital Twin node and the second Digital Twin node, becomes unavailable, Digital Twin nodes on either side of the third Digital Twin node, referred to as a near-side neighbor and a far-side neighbor, associate with a new Digital Twin node. In some embodiments, the new Digital Twin node assumes the link code of the third Digital Twin node. In some embodiments, the new Digital Twin node is assigned a recency score different from the recency score previously assigned to the third Digital Twin node.

According to a third embodiment, a Wi-Fi network is disclosed. The Wi-Fi network comprises a controller; a low power Wi-Fi device; and one or more Digital Twin nodes, associated with the low power Wi-Fi device, wherein an association between the low power Wi-Fi device and each Digital Twin node is assigned a recency score, wherein the recency score is used by the controller to identify the Digital Twin node most recently associated with the low power Wi-Fi device. In some embodiments, the low power Wi-Fi device assigns a different recency score each time it forms an association with a Digital Twin node. In some embodiments, the Wi-Fi network comprises at least a second Digital Twin node, wherein each Digital Twin node is assigned a link code, indicative of its position between the controller and the low power Wi-Fi device.

### BRIEF DESCRIPTION OF THE DRAWINGS

For a better understanding of the present disclosure, reference is made to the accompanying drawings, in which like elements are referenced with like numerals, and in which:

FIG. 1 shows the sequence used by a sleepy node to associate with a Digital Twin;

FIG. 2 shows the sequence used by the sleepy node to associate with a new Digital Twin;

FIG. 3 shows the sequence used by the controller to identify the correct Digital Twin;

FIG. 4A shows the sequence used to update a chain of Digital Twins according to one embodiment;

FIG. 4B shows the sequence used by the controller to identify the chain of Digital Twins according to one embodiment;

FIG. 5 shows the sequence used to update a chain of Digital Twins according to another embodiment; and

FIG. 6 shows a block diagram of an exemplary Wi-Fi device.

### DETAILED DESCRIPTION

This disclosure describes a system and method by which a low power Wi-Fi device may associate with a Digital Twin. Techniques to address the unavailability of a Digital Twin are also disclosed.

A wireless network may include an access point, one or more controllers, one or more always-on nodes, which may serve as proxy nodes, and one or more low power Wi-Fi devices, also referred to sleepy nodes. The access point serves as the network as connectivity provider between the controllers, always-on nodes and sleepy nodes in the network. The controllers serve as the control point for a particular application. For example, a device may serve as the controller for a home automation network (or a “smart home”). This controller may coordinate lighting, switches, sensors, and other devices that allow the home to be controlled. Proxy devices are those nodes that are always powered on and have the ability to serve as the proxy for another node. Finally, sleepy nodes are nodes that may be in a low power mode for an extended period of time. There may be other types of devices as well. For example, there may be devices that are always powered on that cannot serve as a proxy node.

Each of these types of device may include a processing unit and an associated memory device. The processing unit may be any suitable component, such as a microprocessor, embedded processor, an application specific circuit, a programmable circuit, a microcontroller, or another similar device. The memory device contains the instructions, which, when executed by the processing unit, enable the device to perform the functions described herein. This memory device may be a non-volatile memory, such as a FLASH ROM, an electrically erasable ROM or other suitable devices. In some embodiments, the memory device may be a volatile memory, such as a RAM or DRAM. In some embodiments, both volatile and non-volatile memory may be used.

The devices include a wireless network interface and an antenna to enable wireless communications using Wi-Fi.

Having described the topology of a typical Wi-Fi network, as well as the architecture of a device in that network, a description of the various enhancements is provided.

Throughout the description that follows, groupcast messages may be transmitted. A groupcast message is one that can be addressed to multiple nodes in the wireless network. These may follow well-known protocols such as Multicast Internet Protocol (IP) addressing defined in the Transport Control Protocol-Internet Protocol (TCP/IP) specification. The formation and addressing of the groups of nodes that receive such messages is left to the implementation of specific embodiments.

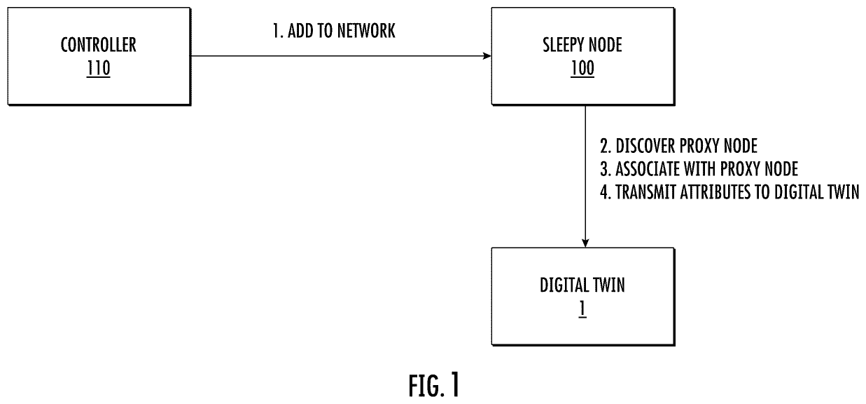

First, when a sleepy node is first powered on in a new environment, it needs to be added to the network. This process is known as commissioning. After it has been added to the network by the controller 110, the sleepy node 100 attempts to discover whether there are also proxy nodes available that can serve as its proxy device while it is in sleep mode. This proxy node is referred to as a Digital Twin. This process is shown in FIG. 1. The sleepy node 100 transmits a groupcast “discover message” to all nodes in the network to determine which nearby nodes may serve as its Digital Twin. One or more proxy nodes may respond to this discover message. A proxy node must only respond if it is able to serve as a Digital Twin and has sufficient resources (memory, etc.) to serve as a Digital Twin. For instance, if a proxy node is limited in the number of sleepy nodes it can represent, it must stop responding to new discovery or association requests once that limit is reached. The sleepy node 100 then selects one of these nodes as its Digital Twin node 1. The criteria for selecting a Digital Twin node is implementation specific and may depend on factors, such as proximity. Once it selects a Digital Twin node 1, the sleepy node 100 associates with that node, such that the Digital Twin node 1 now recognizes that it is to serve as the Digital Twin for this sleepy node 100. The protocol for forming such an association is implementation specific. Once this is done, the sleepy node 100 transmits its attributes and their current values to the Digital Twin node 1. These attributes may be state information about the sleepy node 100, settings, or other information. The set of attributes may be referred to as an Attribute Table. Note that after this procedure is complete, both the sleepy node 100 and the Digital Twin node 1 are aware of the association. Through other messages, as described later, the controller 110 may also become aware of this association.

Thereafter, the Digital Twin node 1 is responsible for handling all communications on behalf of the sleepy node 100 while it is in sleep mode. Specifically, it may receive commands from the controller 110. In some embodiments, the Digital Twin node 1 may be able to process the command on behalf of the sleepy node 100. For example, the sleepy node 100 may be a sensor and the command from the controller 110 may be a change to its sensitivity setting. In this case, the Digital Twin node 1 may simply update this attribute in its Attribute Table. For other commands, the Digital Twin node 1 may not have the ability to perform the command. In this case, the Digital Twin node 1 simply holds the command in a buffer, which is provided to the sleepy node 100 when it awakens.

The Digital Twin node 1 may also transmit attribute reports of the sleepy node 100 periodically or on demand to controllers 110 in the network that request such reports. An attribute report provides a list of one or more attributes and their latest values. The protocol for requesting attribute reports, whether they are sent periodically or on demand, and their frequency of transmission is implementation specific. The Digital Twin node 1 uses the values stored in its Attribute Table to form the attribute reports for the sleepy node 100 it represents.

Thus, when the sleepy node 100 wakes up, it must execute a sequence of operations to understand any changes that occurred while it was in sleep mode. For example, the sleepy node 100 must reconcile its Attribute Table with that stored in the Digital Twin node 1. As noted above, certain attributes may have changed due to the commands that the Digital Twin node 1 was able to execute on behalf of the sleepy node 100. The sleepy node 100 will update the attributes in its own Attribute Table if it has not made any changes to those attributes in the meantime. However, if the sleepy node 100 has also updated one or more of the same attributes as those modified by the Digital Twin node 1, it must resolve the conflict to determine which value is the correct one to store for each attribute. The specific rules for such conflict resolution are outside the scope of this invention. Then, the Digital Twin node 1 will forward any buffered commands to the sleepy node 100. The sleepy node 100 must then process any commands that it received. Finally, the execution of these buffered commands may affect the attributes of the sleepy node 100. Therefore, the sleepy node 100 may then send its updated attributes to the Digital Twin node 1 after processing the commands.

This explains the operation of the Digital Twin node 1 and the sleepy node 100 during normal operation.

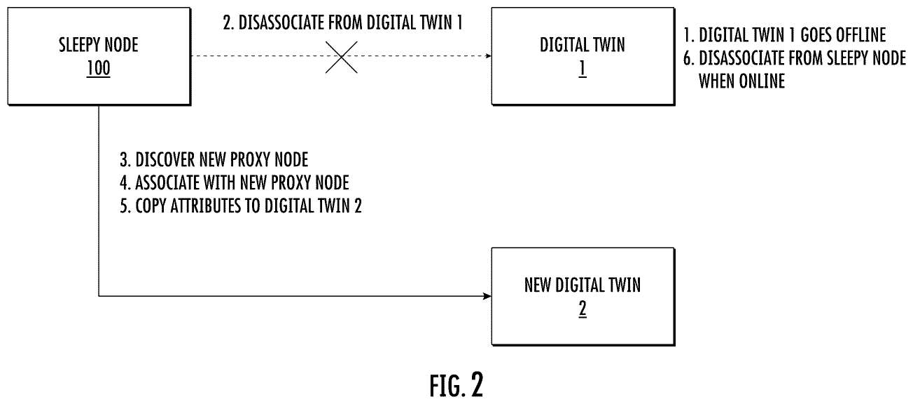

However, it is possible that the Digital Twin node 1 may become unavailable. For example, the Digital Twin node 1 may be powered off, removed from the network, or fail. Upon waking, the sleepy node 100 will detect that it is unable to communicate with its Digital Twin node 1. In this situation, the sleepy node 100 must find a new Digital Twin node 2 to replace the original Digital Twin node 1. FIG. 2 shows this process. First, as shown in the figure, the original Digital Twin node 1 becomes unavailable. The sleepy node 100 then disassociates with this Digital Twin node 1. Note that the Digital Twin node 1 is unaware that this has occurred, as it is unavailable. The sleepy node 100 then repeats the sequence shown in FIG. 1, where it issues a groupcast “discover message” to identify other proxy nodes. After the available proxy nodes respond, the sleepy node 100 selects one of these as its new Digital Twin node 2 and associates with that new Digital Twin node 2. It then transmits its attributes to the new Digital Twin node 2. The controller 110 may then become aware of this new association at a later time.

One potential issue arises if the original Digital Twin node 1 becomes available again at a later time. Since it is unaware that the sleepy node 100 has made an association with a new Digital Twin node 2, it may believe this it is still the Digital Twin node for this sleepy node. One approach to address this issue is through the use of a recency score.

When the sleepy node 100 makes its first association, it assigns a first recency score to this association. This first recency score is provided to the Digital Twin node 1 as well. Thus, when the controller 110 learns of the association between a sleepy node 100 and its Digital Twin node 1, it also learns this first recency score. The Digital Twin node 1 must store its own recency score, and include it in its response to groupcast “discover messages” or “discover queries”. If, as shown in FIG. 2, the original Digital Twin node 1 becomes unavailable, and the sleepy node 100 forms an association with a new Digital Twin node 2, the sleepy node 100 will assign a second recency score to this new association.

In one embodiment, the sleepy node 100 assigns recency scores sequentially, such that the second recency score will be greater than the first recency score. In this way, when the original Digital Twin node 1 becomes available again after a period of unavailability, it transmits a groupcast “discover query” with its sleepy node's unique node identifier to discover if there are other Digital Twin nodes in the network that represent the same sleepy node. When this happens, the new Digital Twin node 2 will respond to the query. The original Digital Twin node 1, upon receiving the response will learn that there is now a new Digital Twin with a recency score that is greater than its own recency score. This will indicate to the original Digital Twin node 1 that the sleepy node 100 has found a new Digital Twin node 2 and it will disassociate itself from the sleepy node 100. Further, if the controller 110 issued a query and both the original Digital Twin node 1 and the new Digital Twin node 2 responded, the controller 110 is able to use their different recency scores to determine which proxy node is the current Digital Twin node. Thus, the use of a recency score allows the controller 110, as well as the original Digital Twin node 1 to determine the most recent Digital Twin association.

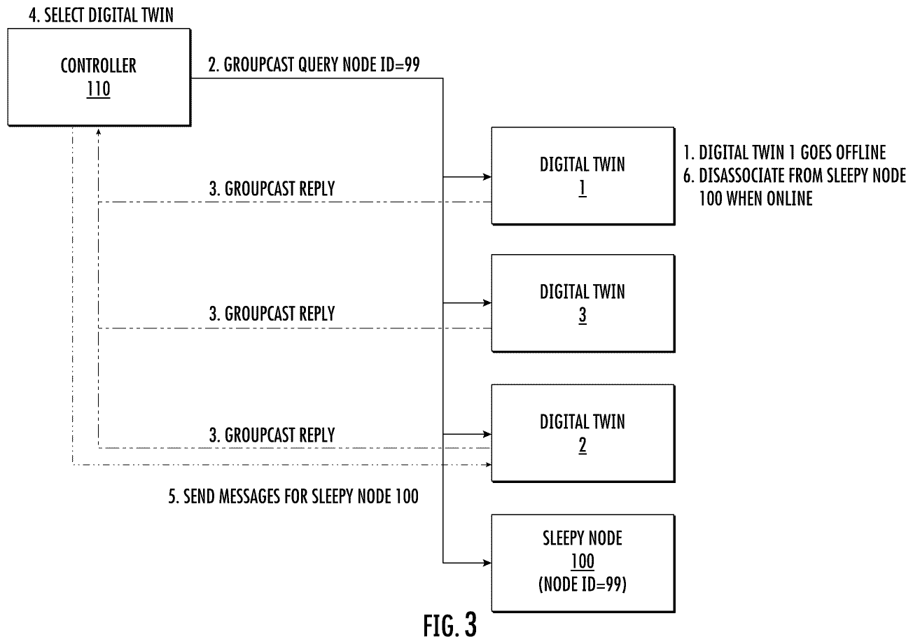

FIG. 3 shows in more detail how the controller 110 determines the appropriate Digital Twin. In this figure, it is assumed that Digital Twin node 1 previously went offline and a new association was created for the sleepy node 100. The sequence begins with the controller 110 transmitting a Groupcast “discover query”, asking about the nodes that are associated with the sleepy node 100 (which in this figure is known as NodeID 99). In response, all of the Digital Twin nodes that had an association with the sleepy node 100 reply to the Groupcast. The controller 110 then checks the recency score of each of these nodes that responded, looking for the greatest recency score, and ignoring the Digital Twins with a smaller recency score which indicates that they are no longer associated with the sleepy node 100. The Digital Twin with the greatest recency score is treated as the new Digital Twin node 2, and future messages for the sleepy node 100 will be transmitted from the controller 110 to this new Digital Twin node 2. Note that Digital Twin node 1 has a recency score that is less than that supplied by new Digital Twin node 2, and therefore is not considered to be the Digital Twin for the sleepy node 100.

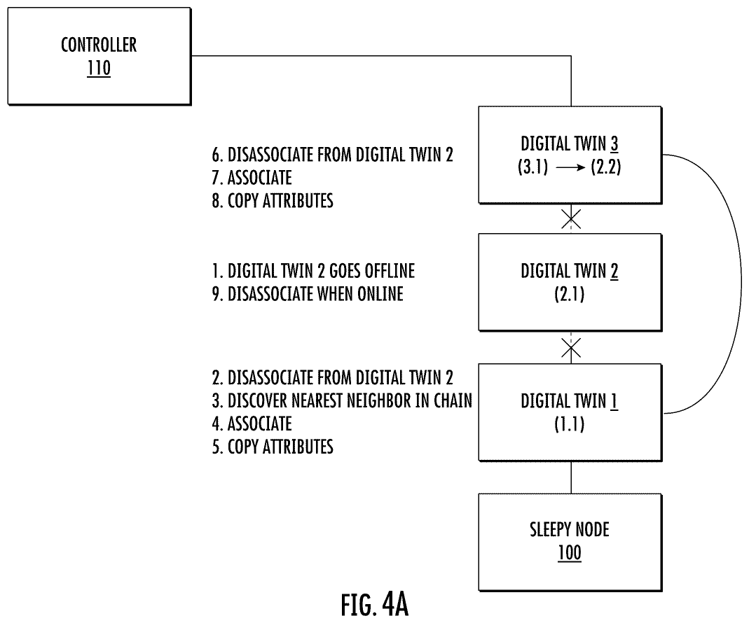

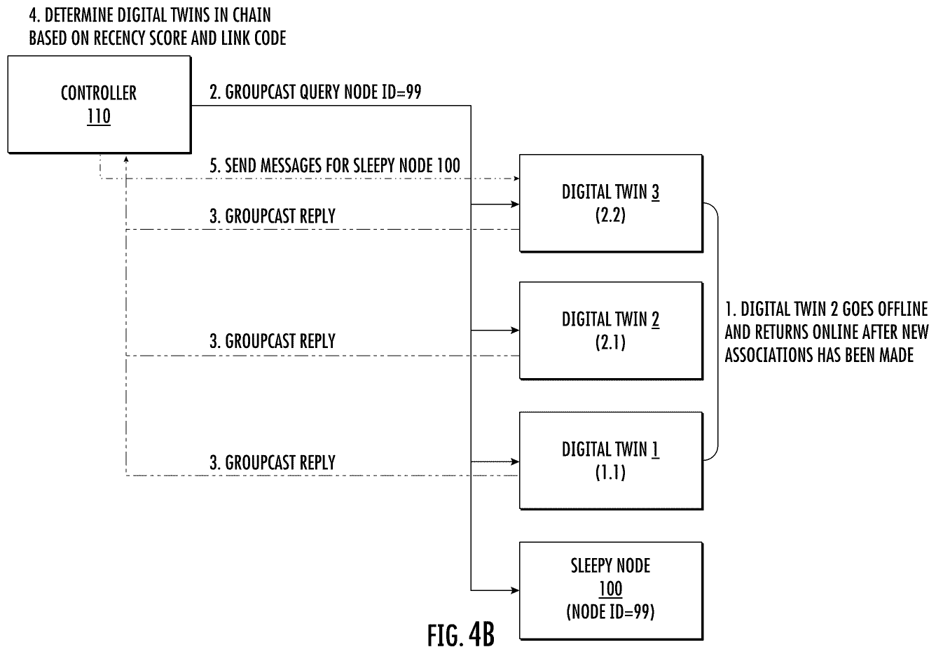

Another concept is that of a chain of Digital Twin nodes. In certain embodiments, a chain of interconnected Digital Twin nodes may be created. For example, the distance between the controller 110 and the sleepy node 100 may be such that two or more hops are needed to reach the sleepy node 100. Also, Digital Twin nodes may not be able to support an unlimited number of sleepy nodes. In either of these cases, there may be a chain of Digital Twins. As described above, the sleepy node 100, at the commissioning stage, may select and associate with a Digital Twin node 1. This Digital Twin node 1 may then select and associate with another Digital Twin node, and so on until the last Digital Twin node connects directly to the controller 110. This is shown in FIG. 4A as there are three Digital Twin nodes located between the controller 110 and the sleepy node 100. These chains may be defined using Link Codes. For example, the Digital Twin node 1 closest to the sleepy node 100 may be assigned a Link Code having a value of “1”. The Digital Twin node 2 that is directly associated with Digital Twin node 1 may have a Link Code of “2”. This continues, such that the Digital Twin node farthest from the sleepy node 100 has the greatest Link Code. While FIG. 4A shows three such Digital Twin nodes, it is understood that the number of Digital Twin nodes in the chain is not limited to any particular number.

Thus, each Digital Twin may have two values, a Recency Score and a Link Code. This combination allows the replacement of a Digital Twin node in a chain when it becomes unavailable.

In the example in FIG. 4A, assume that the recency score of each Digital Twin node was initially set to 1. Additionally, assume that the Link Code for Digital Twin 1 was “1”; Digital Twin 2 was “2” and Digital Twin 3 was “3”. A couplet, defined as the Link Code, followed by a dot and then the recency score, can be used to define each Digital Twin node. Thus, these Digital Twins are identified as (1.1), (2.1) and (3.1). At a later time, Digital Twin 2 becomes unavailable. The Digital Twin node that is closer to the sleepy node (in this case, Digital Twin 1) recognizes this and disassociates from Digital Twin 2. It then issues a Groupcast Discover message and identifies a new Digital Twin node to associate itself with. In one embodiment, the new Digital Twin node may be identified simply as the next link in the chain by referring to its current Link Code (in this case, Digital Twin 3). Consequently, Digital Twin 1 associates with Digital Twin 3, and copies the attributes associated with the sleepy node 100 to Digital Twin 3. Note that because of this change in configuration, Digital Twin 1 now provides Digital Twin 3 with a Link Code of 2 (since it is now second in the chain). Furthermore, since this is the second time that Digital Twin 1 has associated with a Digital Twin on behalf of the sleepy node 100, Digital Twin 3 also has a recency score of 2. Thus, the couplet associated with Digital Twin 3 has changed from (3.1) to (2.2). In some embodiments, Digital Twin 1 also updates its recency score, since its associations have been changed. In this scenario, Digital Twin 1 has changed from (1.1) to (1.2). Thus, in certain embodiments, the Digital Twins on opposite sides of the removed Digital Twin both update their recency score.

At a later time, the original Digital Twin 2 may become available. To determine whether it is still part of the chain, it transmits a groupcast “discover query” with its sleepy node's unique node identifier to discover if there are other Digital Twin nodes in the network that represent the same sleepy node. When this happens, the Digital Twin 1 and Digital Twin 3 node will respond to the query. The original Digital Twin 2, upon receiving the response will learn that there is now a new Digital Twin (Digital Twin 3) with the same link code as itself and a recency score that is greater than its own recency score. Based on this, it realizes that Digital Twin 3 has replaced it in the chain and that it is no longer part of this chain. It then disassociates from that chain. While FIG. 4A shows only 3 Digital Twins in the chain, this process applies to a chain of arbitrary length. Thus, if there was a Digital Twin 4 associated with Digital Twin 3 between Digital Twin 3 and the controller 110, Digital Twin 3 would inform Digital Twin 4 that its new Link Code is now 3. Its recency score may remain unchanged. In another embodiment, the recency score for Digital Twin 4 may be increased.

Further, if, as shown in FIG. 4B, the controller 110 issued a query and both the original Digital Twin node 2 and the new Digital Twin node 3 responded, the controller 110 is able to use their different recency scores and matching link code to determine which proxy node is the current Digital Twin node. Thus, the use of a recency score and a link code allows the controller 110, as well as the original Digital Twin node 2 to determine the most recent Digital Twins in the chain.

Note that FIG. 4B shows the controller 110 attached to Digital Twin 3 because it had the greatest Link Code and greater recency score. However, the controller 110 may select to associate with any Digital Twin node in the chain. In some embodiments, as explained above, the controller 110 may issue the Groupcast described above and receive multiple responses. Each of these responses may include both the Link Code and the recency score. In certain embodiments, the controller 110 may associate with a node having the highest Link Code, although it may choose a different Link Code. The controller 110 then checks all of the responses that have the chosen Link Code, looking for the greatest recency score. The node with the chosen Link Code and the greatest recency score is then selected as the Digital Twin that the controller 110 will use for all communication with the sleepy node 100. The criteria for selecting the Link Code are implementation specific and may depend on factors such as proximity to the controller 110 and proximity to the sleepy node 100.

FIGS. 4A-4B show a scenario where a Digital Twin in the chain becomes unavailable, and the neighboring Digital Twins simply connect to each other.

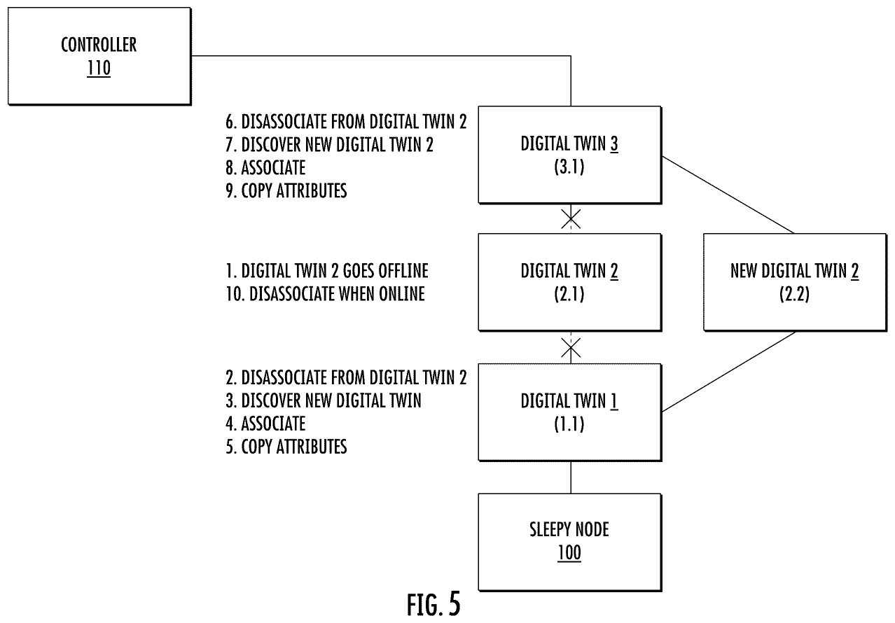

However, other embodiments are also possible. FIG. 5 shows a scenario where one of the Digital Twin nodes in the chain becomes unavailable and a new Digital Twin node is inserted in its place. In this embodiment, the following sequence may be followed. First, one of the Digital Twin nodes (Digital Twin 2) becomes unavailable. In this configuration, the Digital Twin node adjacent to the Digital Twin 2 but closer to the sleepy node (Digital Twin 1) may be referred to as the Near-side Neighbor, while Digital Twin 3 is referred to as the Far-side Neighbor. The Near-side Neighbor (i.e. the Digital Twin node with a Link Code that is one less than that of the unavailable Digital Twin node), recognizes that this Digital Twin node 2 is unavailable and disassociates from that node. It then performs a discovery mechanism to identify other nodes that may serve as part of the chain. Once the Near-side Neighbor discovers these nodes, it selects one and associates with it. That new node (referred to as New Digital Twin 2) has the Link Code that is the same as that of the unavailable node, however, its recency score is greater, since it is the newest association. Finally, the Near-side Neighbor forwards the attributes of the sleepy node 100 to the new Digital Twin 2. Note that the Digital Twin that was adjacent to the unavailable node but closer to the controller 110, which is referred to as the Far-side Neighbor, may also notice that the Digital Twin 2 became unavailable. In one embodiment, the Near-side Neighbor may also inform the Far-Side Neighbor that it has found a replacement for Digital Twin 2. The Near-side Neighbor shares details about the new Digital Twin 2 with the Far-side Neighbor. The Far-side Neighbor may then proceed to form an association with the new Digital Twin 2. In response, New Digital Twin 2 may forward the attributes associated with the sleepy node 100 to the Far-side Neighbor. Alternatively, the New Digital Twin 2 may perform the discovery procedure and find a node (Digital Twin 3), that has a Link Code that is one greater than its own Link Code, and associate with this node.

The following summarizes many of the operations that are used to implement this concept.
During the addition of sleepy nodes to the Wi-Fi network, the sleepy node 100 forms a permanent association with an always-on node, referred to as a proxy node. This becomes the Digital Twin. This may be performed during the commissioning of the sleepy node.
When a Digital Twin in a chain of Digital Twins becomes unavailable, the node closest to the unavailable Digital Twin must disassociate itself from this Digital Twin and associate itself with a new Digital Twin.
Controllers 110 may discover one or more Digital Twins directly and indirectly associated with a particular sleepy node 100 using a Groupcast Service Discovery mechanism.
Digital Twins may send attribute reports to controllers 110 from their copy of the sleepy node's Attribute Table periodically or on demand.
Controllers 110 send any commands intended for a sleepy node 100 to one of the Digital Twins associated with that sleepy node.
When the sleepy node 100 wakes up, it synchronizes its attributes and processes any buffered commands from the Digital Twin node.

Further, with respect to command handling, the sleepy node 100 may require certain commands to be sent to it directly by controllers 110 when it is awake. For example, if a command involves updating the firmware on the sleepy node 100, the firmware update protocol may require real-time communication directly between the controller 110 and the sleepy node 100. In one embodiment, the user will be required to restart the sleepy node 100 which will then initiate a firmware update protocol with the controller 110 as part of its boot-up sequence before it goes into low power mode. The sleepy node 100 may allow a Digital Twin node to request an extension in its wake duration if necessary to enable certain commands to be processed or when the number of buffered commands are unable to be processed within the initial wake duration. The Digital Twin must be able to receive all commands intended for the sleepy node 100. In this scenarios, the Digital Twin may process a command on behalf of the sleepy node 100 by updating its copy of the attributes associated with the sleepy node 100. Alternatively, the Digital Twin may buffer commands that it cannot process by updating the attributes.

Note that while the concept of link codes is described above with respect to chains of Digital Twins, it may also be implemented in the simpler configurations, such as the network shown in FIG. 1.

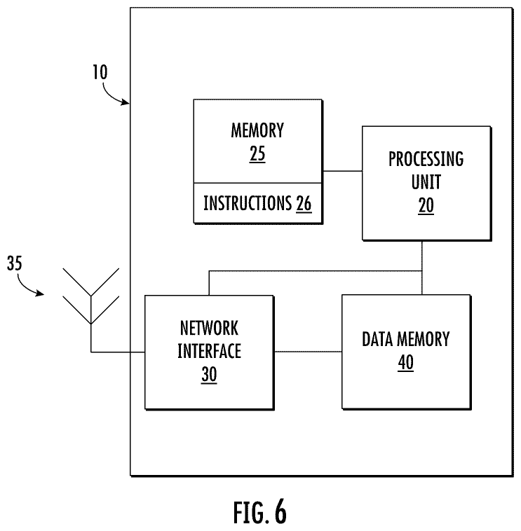

FIG. 6 shows a block diagram that may apply to the Wi-Fi devices described above. Note that this architecture may apply to Digital Twin nodes as well as sleepy nodes.

The Wi-Fi device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Wi-Fi device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions 26 may be downloaded into the memory device 25, such as for example, over a network connection (not shown), via CD ROM, or by another mechanism. These instructions 26 may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 6. The second computer readable non-transitory media may be a CDROM, or a different memory device, which is located remote from the Wi-Fi device 10. The instructions contained on this second computer readable non-transitory media may be downloaded onto the memory device 25 to allow execution of the instructions by the Wi-Fi device 10.

The Wi-Fi device 10 also includes a Wi-Fi network interface 30 that connects with a Wi-Fi network using an antenna 35.

The Wi-Fi device 10 may include a data memory device 40 in which data that is received and transmitted by the Wi-Fi network interface 30 is stored. This data memory device 40 is traditionally a volatile memory. The processing unit 20 has the ability to read and write the data memory device 40 so as to communicate with the other devices in the Wi-Fi network.

Although not shown, the Wi-Fi device 10 also has a power supply, which may be a battery or a connection to a permanent power source, such as a wall outlet. For example, sleepy nodes 100 may utilize a battery, while Digital Twin nodes may utilize a permanent power source, such as a wall outlet.

While the processing unit 20, the memory device 25, the Wi-Fi network interface 30, and the data memory device 40 are shown in FIG. 6 as separate components, it is understood that some or all of these components may be integrated into a single electronic component. Rather, FIG. 6 is used to illustrate the functionality of the Wi-Fi device 10, not its physical configuration.

This system and method has many advantages. By utilizing a Digital Twin, a sleepy node is able to remain in sleep mode for extended periods of time, while still remaining part of the Wi-Fi network. Further, by allowing the sleepy node to find a Digital Twin and automatically associate with that Digital Twin, the operation of the controller is simplified. Further, the use of recency scores and Link Codes allows simpler reconfiguration of the network in the event that a Digital Twin becomes unavailable.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for creating a Digital Twin node for a low power Wi-Fi device in a Wi-Fi network, comprising:
issuing from the low power Wi-Fi device, a groupcast “discovery message” to identify proxy nodes that are able to serve as the Digital Twin node;
receiving, at the low power Wi-Fi device, responses from proxy nodes that are able to serve as the Digital Twin node;
selecting a first proxy node of the proxy nodes as the Digital Twin node and forming an association with the first proxy node; and
assigning a recency score to the Digital Twin node, which is indicative of how recently the association was formed, wherein the recency score is used by a controller to identify a most recent Digital Twin node associated with the low power Wi-Fi device.

2. The method of claim 1, wherein each time the low power Wi-Fi device forms an association with one of the proxy nodes, it assigns a different recency score.

3. The method of claim 1, wherein each time the low power Wi-Fi device forms an association with one of the proxy nodes, it increases the recency score.

4. The method of claim 1, wherein, after the association is formed, the Digital Twin node becomes unavailable, and wherein, in response, the low power Wi-Fi device:
disassociates from the Digital Twin node;
issues a groupcast “discovery message” to identify proxy nodes that are able to serve as a new Digital Twin node;
receives responses from proxy nodes that are able to serve as the new Digital Twin node;
selects a second proxy node of the proxy nodes as the new Digital Twin node and forms a new association with the second proxy node; and
assigns a second recency score to the new Digital Twin node, different from the recency score assigned to the Digital Twin node.

5. The method of claim 4, wherein after the new association is formed, the Digital Twin node becomes available, and wherein the Digital Twin node:
transmits a groupcast “discover query” with a unique node identifier associated with the low power Wi-Fi device to discover if there are other Digital Twin nodes in the Wi-Fi network;
receives a response from the new Digital Twin node, wherein the response includes the second recency score;
compares the second recency score to its recency score and determines that it is no longer associated with the low power Wi-Fi device; and
disassociates itself from the low power Wi-Fi device.

6. The method of claim 4, wherein after the low power Wi-Fi device forms the new association, the controller:
issues a query to discover proxy nodes associated with the low power Wi-Fi device;
receives a response from the Digital Twin node and the new Digital Twin node;
compares the second recency score to the recency score assigned to the Digital Twin node; and
selects the new Digital Twin node to communicate with regarding the low power Wi-Fi device, based on the recency score and the second recency score.

7. The method of claim 1, wherein, after the association is formed, the low power Wi-Fi device also assigns a link code to the Digital Twin node.

8. A method of configuring and maintaining a chain of Digital Twin nodes, comprising:
forming a chain using a plurality of Digital Twin nodes between a controller and a low power Wi-Fi device, wherein a first Digital Twin node is closest to the low power Wi-Fi device and a second Digital Twin node is closest to the controller; and
assigning each Digital Twin node in the chain a unique link code, wherein the link code is indicative of a position of a respective Digital Twin node in the chain.

9. The method of claim 8, further comprising:
creating an association between pairs of adjacent Digital Twin nodes in the chain; and
assigning a recency score to each association, which is indicative of when the association was formed.

10. The method of claim 9, wherein after a third Digital Twin node in the chain, disposed between the first Digital Twin node and the second Digital Twin node, becomes unavailable, Digital Twin nodes on either side of the third Digital Twin node, referred to as a near-side neighbor and a far-side neighbor, associate with each other.

11. The method of claim 10, wherein all Digital Twin nodes disposed between the third Digital Twin node and the controller are assigned new link codes.

12. The method of claim 11, wherein link codes of all Digital Twin nodes disposed between the third Digital Twin node and the controller are decremented.

13. The method of claim 10, wherein the far-side neighbor receives a new recency score.

14. The method of claim 10, wherein the near-side neighbor and the far-side neighbor are assigned new recency scores.

15. The method of claim 9, wherein after a third Digital Twin node in the chain, disposed between the first Digital Twin node and the second Digital Twin node, becomes unavailable, Digital Twin nodes on either side of the third Digital Twin node, referred to as a near-side neighbor and a far-side neighbor, associate with a new Digital Twin node.

16. The method of claim 15, wherein the new Digital Twin node assumes the link code of the third Digital Twin node.

17. The method of claim 15, wherein the new Digital Twin node is assigned a recency score different from the recency score previously assigned to the third Digital Twin node.

18. A Wi-Fi network, comprising:
a controller;
a low power Wi-Fi device; and
one or more Digital Twin nodes, associated with the low power Wi-Fi device, wherein an association between the low power Wi-Fi device and each Digital Twin node is assigned a recency score, wherein the recency score is used by the controller to identify the Digital Twin node most recently associated with the low power Wi-Fi device.

19. The Wi-Fi network of claim 18, wherein the low power Wi-Fi device assigns a different recency score each time it forms an association with a Digital Twin node.

20. The Wi-Fi network of claim 18, further comprising at least a second Digital Twin node, wherein each Digital Twin node is assigned a link code, indicative of its position between the controller and the low power Wi-Fi device.
